(19) United States
(12) Patent Application Publication
(10) Pub. No.: US 2021/0070370 A1
(43) Pub. Date: Mar. 11, 2021

(54) IMPACT ABSORPTION DEVICE

(71) Applicants: AISIN SEIKI KABUSHIKI KAISHA, Kariya-shi (JP); AISIN KEIKINZOKU KABUSHIKI KAISHA, Imizu-shi (JP)

(72) Inventors: Syunji MORI, Kariya-shi (JP); Shunji SHIBATA, Kariya-shi (JP); Masaaki YOSHIMURA, Kariya-shi (JP); Kenji TAMAKI, Kariya-shi (JP); Kiyoichi KITA, Okazaki-shi (JP); Jun SYOBO, Anjo-shi (JP)

(73) Assignees: AISIN SEIKI KABUSHIKI KAISHA, Kariya-shi (JP); AISIN KEIKINZOKU KABUSHIKI KAISHA, Imizu-shi (JP)

(21) Appl. No.: 16/994,916

(22) Filed: Aug. 17, 2020

(30) Foreign Application Priority Data
Sep. 5, 2019 (JP) 2019-161731

(51) Int. Cl. B62D 21/15; B62D 25/20

(52) U.S. Cl. CPC B62D 21/157; B62D 25/20

(57) ABSTRACT

An impact absorption device includes: a pair of an upper wall portion and a lower wall portion extending in the vehicle front-rear direction and placed to face each other; and a plurality of ribs extending in the vehicle front-rear direction between the upper wall portion and the lower wall portion, the ribs being arranged at predetermined intervals in the vehicle width direction so as to divide a space between the upper wall portion and the lower wall portion into a plurality of sections extending in the vehicle front-rear direction. Among the sections, three consecutive sections in an arrangement direction of the sections are configured such that an interval between ribs constituting a central section in the arrangement direction is smaller than an interval between ribs constituting each of sections adjacently placed on both sides of the central section.

### CROSS-REFERENCE TO RELATED APPLICATION

This application claims priority to Japanese Patent Application No. 2019-filed on Sep. 5, 2019, incorporated herein by reference in its entirety.

### BACKGROUND

### 1. Technical Field

The present disclosure relates to an impact absorption device for a vehicle. Particularly, the present disclosure relates to an impact absorption device configured to absorb an impact applied to a side part of a vehicle.

### 2. Description of Related Art

For example, as described in Japanese Unexamined Patent Application Publication No. 2018-90021 (JP 2018-90021 A), there has been known an impact absorption device configured to absorb a collision energy when an object collides with a side part of a vehicle. The impact absorption device includes an upper wall portion and a lower wall portion extending in the vehicle front-rear direction below a doorway of the vehicle. The upper wall portion and the lower wall portion are distanced from each other in the vehicle height direction. The upper wall portion and the lower wall portion are placed so that their plate-thickness directions are along the vehicle height direction. A plurality of ribs is provided between the upper wall portion and the lower wall portion. A space between the upper wall portion and the lower wall portion is divided into a plurality of sections by the ribs. The width of each section (the interval between ribs) decreases as it goes from an end part side of the vehicle in the vehicle width direction to a central part side of the vehicle. In the meantime, as illustrated in FIG. 11, such an impact absorption device 1A has been known that the width of a section Dₙ₊₁ (the interval between a rib Rₙ₊₁, and a rib Rₙ₊₂) is equal to or more than the width of a section Dₙ (the interval between a rib Rₙ and the rib Rₙ₊₁).

When an object collides with a side part of a vehicle to which the impact absorption device 1A is applied, and the object presses the impact absorption device 1A to a central part side of a vehicle body in the vehicle width direction, the impact absorption device 1A deforms to be compressed in the vehicle width direction. That is, parts of the upper wall portion and the lower wall portion constituting the impact absorption device 1A buckle, the parts being placed between the ribs, so that the impact absorption device 1A deforms in a bellows manner. Hereby, a collision energy of the object is absorbed (see FIGS. 13, 14).

### SUMMARY

In a case where an application direction of a pressing load to the impact absorption device 1A is parallel to an arrangement direction (the vehicle width direction) of the sections (see a first experiment in FIGS. 13, 14), the impact absorption device 1A deforms in a bellows manner as described above, so that the collision energy is absorbed efficiently. In the meantime, in a case where the application direction of the pressing load to the impact absorption device 1A is inclined from the arrangement direction (the vehicle width direction) of the sections (the application direction is directed diagonally downward (a second experiment in FIGS. 13, 14)), the impact absorption device 1A deforms to collapse downward (see FIG. 12). In this case, the upper wall portion partially remains without buckling, so that the collision energy may not be sufficiently absorbed (see FIGS. 13, 14).

The present disclosure provides an impact absorption device having improved collision-energy absorption performance. Note that, in the following description of each constituent feature of the present disclosure, a reference sign of a corresponding portion in an embodiment is described within a parenthesis to facilitate understanding of the present disclosure. However, the constituent features of the present disclosure should not be construed limitatively to a configuration of the corresponding portion indicated by the reference sign in the embodiment.

An impact absorption device according to an aspect of the present disclosure is an impact absorption device for absorbing a collision energy by deforming when an object collides with a side part of a vehicle from a lateral side of the vehicle toward a central part side of the vehicle in the vehicle width direction. The impact absorption device includes a pair of an upper wall portion and a lower wall portion, and a plurality of ribs. The upper wall portion and the lower wall portion extend in the vehicle front-rear direction in the side part of the vehicle. The upper wall portion and the lower wall portion are distanced from each other in the vehicle height direction and placed to face each other. The ribs extend in the vehicle front-rear direction between the upper wall portion and the lower wall portion. The ribs are arranged at predetermined intervals in the vehicle width direction so as to divide a space between the upper wall portion and the lower wall portion into a plurality of sections extending in the vehicle front-rear direction. Among the sections, three consecutive sections in an arrangement direction of the sections are configured such that an interval between ribs constituting a central section in the arrangement direction is smaller than an interval between ribs constituting each of sections adjacently placed on both sides of the central section.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a vehicle to which an impact absorption device according to one embodiment of the present disclosure is applied;

FIG. 2 is a perspective view of the impact absorption device in FIG. 1:

FIG. 3 is a front view illustrating a collision form of an object in a first experiment;

FIG. 4 is a schematic view illustrating a principle that an upper wall portion and a lower wall portion deform to outside or inside of a section;

FIG. 5A is a schematic view illustrating an outline of a deformation form of the impact absorption device in the first experiment;

FIG. 5B is a schematic view illustrating the outline of the deformation form of the impact absorption device in the first experiment;

FIG. 5C is a schematic view illustrating the outline of the deformation form of the impact absorption device in the first experiment;

FIG. 5D is a schematic view illustrating the outline of the deformation form of the impact absorption device in the first experiment:

FIG. 6 is a front view illustrating a collision from of an object in a second experiment;

FIG. 7A is a schematic view illustrating an outline of a deformation form of the impact absorption device in the second experiment;

FIG. 7B is a schematic view illustrating the outline of the deformation form of the impact absorption device in the second experiment;

FIG. 7C is a schematic view illustrating the outline of the deformation form of the impact absorption device in the second experiment;

FIG. 7D is a schematic view illustrating the outline of the deformation form of the impact absorption device in the second experiment;

FIG. 8 is a graph illustrating changes of a compressive load in the first experiment and the second experiment;

FIG. 9 is a graph illustrating changes of an impact absorption amount (a collision energy absorption amount) in the first experiment and the second experiment;

FIG. 10 is a front view of an impact absorption device according to a modification of the present disclosure;

FIG. 11 is a front view of an impact absorption device in a related art:

FIG. 12 is a schematic view illustrating an outline of a deformation form, in the second experiment, of the impact absorption device in the related art:

FIG. 13 is a graph illustrating changes of a compressive load in the first experiment and the second experiment in the impact absorption device in the related art; and

FIG. 14 is a graph illustrating changes of an impact absorption amount (a collision energy absorption amount) in the first experiment and the second experiment in the impact absorption device in the related art.

### DETAILED DESCRIPTION OF EMBODIMENTS

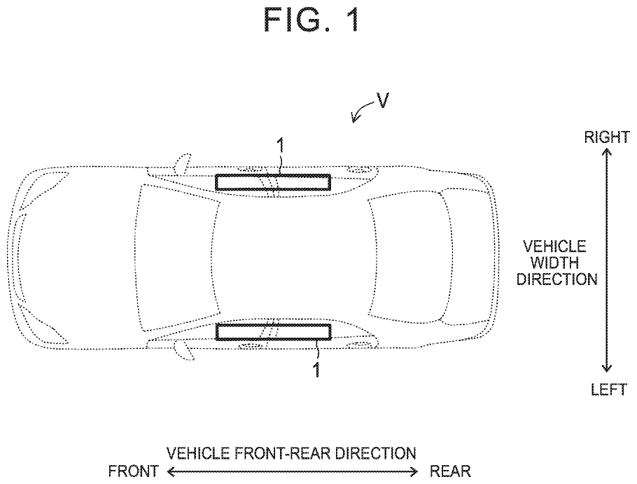

An impact absorption device 1 according to an embodiment of the present disclosure will be described below. As illustrated in FIG. 1, the impact absorption device 1 is provided in each side part of a vehicle V such that the impact absorption device 1 is placed below a floor panel constituting a floor face of a vehicle cabin.

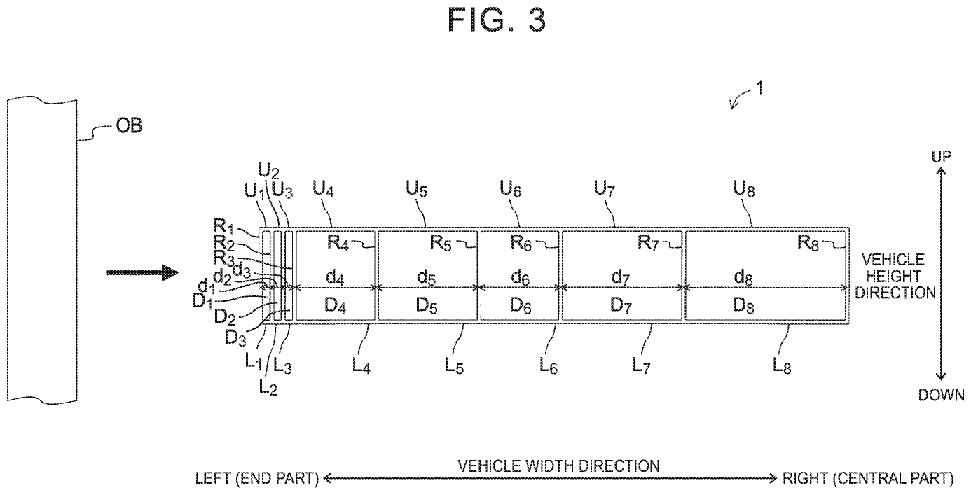

When an object OB (e.g., a columnar object extending in a vertical direction (see FIG. 3)) collides with a side part of the vehicle V from a lateral side of the vehicle V, the impact absorption device 1 is pressed by the object OB to a central part side of the vehicle V in the vehicle width direction. Hereby, the impact absorption device 1 deforms, so that a collision energy of the object OB is absorbed. An entry amount of a member constituting the side part of the vehicle V to the vehicle cabin is reduced by such an impact absorption function.

The impact absorption device 1 provided in a left side part of the vehicle V and the impact absorption device 1 provided in a right side part of the vehicle V have a symmetric shape in the right-left direction, and their other configurations are the same. In view of this, the following deals with the impact absorption device 1 provided in the left side part of the vehicle V, and the impact absorption device 1 provided in the right side part is not described herein.

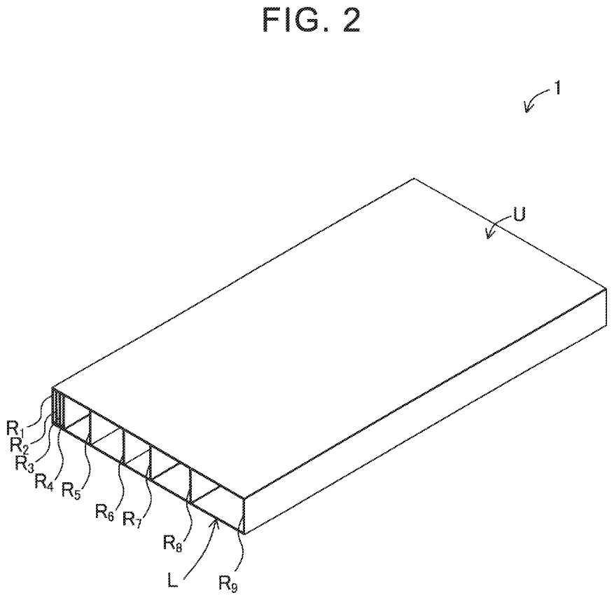

As illustrated in FIG. 2, the impact absorption device 1 extends in the vehicle front-rear direction. The impact absorption device 1 is an extruded molded product formed integrally by extrusion of an aluminum material. The impact absorption device 1 has a tubular shape extending in the vehicle front-rear direction. The impact absorption device 1 is assembled to the vehicle V such that the extrusion direction of the aluminum material is along the vehicle front-rear direction.

As illustrated in FIG. 3, the impact absorption device 1 includes an upper wall portion U and a lower wall portion L. The upper wall portion U and the lower wall portion L are band-plate-shaped parts extending in the vehicle front-rear direction. The upper wall portion U and the lower wall portion L are placed such that their plate-thickness directions are along the vehicle height direction. The upper wall portion U and the lower wall portion L are distanced from each other in the vehicle height direction and are placed to face each other. A left end and a right end of the upper wall portion U are placed right above a left end and a right end of the lower wall portion L, respectively. The plate thickness of the upper wall portion U is equal to the plate thickness of the lower wall portion L.

Ribs R₁ to R₉ are provided between the upper wall portion U and the lower wall portion L. The ribs R₁ to R₉ are band-plate-shaped parts extending in the vehicle front-rear direction. Respective plate thicknesses of the ribs R₁ to R₉ are equal to the plate thickness of the upper wall portion U (the plate thickness of the lower wall portion L). The ribs R₁ to R₉ are placed such that their plate-thickness directions are along the vehicle width direction. First end parts, in the width direction (the vehicle height direction), of the ribs R₁ to R₉ are connected to a bottom face of the upper wall portion U, and second end parts, in the width direction, of the ribs R₁ to R₉ are connected to an upper face of the lower wall portion L.

The rib R₁ is placed in the left ends of the upper wall portion U and the lower wall portion L. Further, the rib R₉ is placed in the right ends of the upper wall portion U and the lower wall portion L. The ribs R₂ to R₈ are placed in this order at predetermined intervals as described below between the rib R₁ and the rib R₉. Hereby, a space between the upper wall portion U and the lower wall portion L is divided into eight sections D₁ to D₈. That is, a part between a rib Rₙ (=_{1, 2, . . . , 8}) and a rib Rₙ₊₁ corresponds to a section Dn. In the following description, a “width dₙ of the section Dₙ” indicates an interval (a distance in the vehicle width direction) between the rib Rₙ and the rib Rₙ₊₁ constituting the section Dₙ. Further, a part, of the upper wall portion U, that constitutes the section Dₙ (that is, a part between the rib Rₙ and the rib Rₙ₊₁) is referred to as an upper wall portion Uₙ. Further, a part, of the lower wall portion L, that constitutes the section Dₙ (that is, a part between the rib Rₙ and the rib Rₙ₊₁) is referred to as a lower wall portion Lₙ.

A width d₁ of the section D₁, a width d₂ of the section D₂, and a width d₃ of the section D₃ are the same. A width da of the section D₄ is slightly larger than the width d₃ of the section D₃, and a width d₅ of the section D₅ is further larger than the width d₄ of the section D₄. A width d₆ of the section D₆ is smaller than the width d₅ of the section D₅. A width d₇ of the section D₇ is larger than the width d₆ of the section D₆, and a width d₈ of the section D₈ is further larger than the width d₇ of the section D₇. More specifically, the widths d₁ to d₈ are set as illustrated in Table 1.

TABLE 1

| d₁ | d₂ | d₃ | d₄ | d₅ | d₆ | d₇ | d₈ |
|---|---|---|---|---|---|---|---|
| 3 mm | 3 mm | 3 mm | 22.1 mm | 27.2 mm | 22.1 mm | 33.2 mm | 44.2 mm |

Next will be described results (simulation results) of a first experiment and a second experiment about collision-energy absorption performance of the impact absorption device 1.

### Result of First Experiment

In the first experiment, a columnar object OB was caused to collide, from the left side, with a central part of the impact absorption device 1 in the vehicle front-rear direction (see FIG. 3). Note that the object OB extends in the vertical direction and slides from the left side to the right side of the vehicle V. When the widths d₁ to d₈ were set as illustrated in Table 1, the sections D₁ to D₈ were crushed in this order as described below.

The following describes deformation forms (crush forms of the sections D₁ to D₈) of the impact absorption device 1. The object OB abuts with a left end face (a left surface of the rib R₁) of the impact absorption device 1. Since the object OB has a columnar shape as described above, a pressing load is concentratedly applied to a linear part extending in the vehicle height direction, the linear part being an abutment part between the rib R₁ and the object OB. Here, the upper wall portion U and the lower wall portion L are connected to an upper end part and a lower end part of the rib R₁ in the vehicle height direction, respectively, and therefore, respective strengths of the upper end part and the lower end part of the rib R₁ are higher than a strength of an intermediate part of the rib R₁ in the vehicle height direction. On this account, the intermediate part of the rib R₁ first bends slightly to the right side. As a result, apart (a left half part), of an upper wall portion U₁, that is placed on the left side from a central part of the upper wall portion U₁ deforms to rotate counterclockwise in the figure around a connecting portion UR₁ between the rib R₁ and the upper wall portion U. Further, a part (a right half part), of the upper wall portion U₁, that is placed on the right side from the central part of the upper wall portion U₁ deforms to rotate clockwise in the figure around a connecting portion UR₂ between the rib R₂ and the upper wall portion U. In the meantime, a part (a left half part), of a lower wall portion L₁, that is placed on the left side from a central part of the lower wall portion L₁ deforms to rotate clockwise in the figure around a connecting portion LR₁ between the rib R₁ and the lower wall portion L. Further, apart (a right half part), of the lower wall portion L₁, that is placed on the right side from the central part of the lower wall portion L₁ deforms to rotate counterclockwise in the figure around a connecting portion LR₂ between the rib R₂ and the lower wall portion L. As such, an intermediate part of the upper wall portion U₁ buckles to project upward, and an intermediate part of the lower wall portion L₁ buckles to project downward.

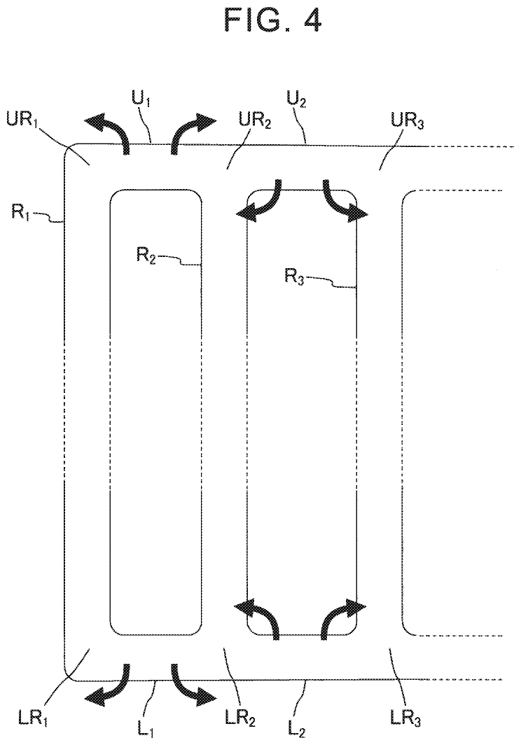

When buckling of the upper wall portion U₁ and the lower wall portion L₁ progresses, and the section D₁ is completely crushed, so that the rib R₁ abuts with the rib R₂, the rib R₂ starts to be pressed to the right side. As described above, the right half part of the upper wall portion U₁ rotates clockwise in FIG. 4 around the connecting portion UR₂, and the right half part of the lower wall portion L₁ rotates counterclockwise in the figure around the connecting portion LR₂. As a counteraction of a load causing such deformations, a load directed diagonally downward toward the left side is applied to a left half part of an upper wall portion U₂, and a load directed diagonally upward to the left side is applied to a left half part of a lower wall portion L₂. Hereby, the upper wall portion U₂ and the lower wall portion L₂ buckle to be folded to the inside of the section D₂.

That is, the left half part of the upper wall portion U₂ deforms to rotate clockwise in the figure around the connecting portion UR₂. Further, a right half part of the upper wall portion U₂ deforms to rotate counterclockwise in the figure around a connecting portion UR₃. In the meantime, the left half part of the lower wall portion L₂ deforms to rotate counterclockwise in the figure around the connecting portion LR₂. Further, a right half part of the lower wall portion L₂ deforms to rotate clockwise in the figure around a connecting portion LR₃. Note that, since the upper wall portion U₂ and the lower wall portion L₂ buckle to be folded to the inside of the section D₂, an uncrushed part slightly remains in the section D₂.

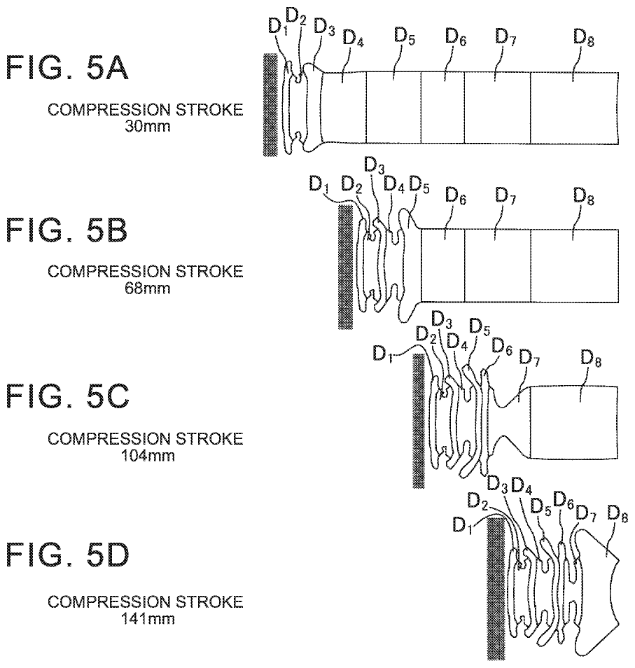

The section D₃ is crushed in the same form as the crush form of the section D₁. That is, an upper wall portion U₃ and a lower wall portion L₃ buckle to project to the outside of the section D₃ (see FIG. 5A). Further, the section Da is crushed in the same form as the crush form of the section D₂. That is, an upper wall portion U₄ and a lower wall portion L₄ buckle to be folded to the inside of the section D₄. Further, the section D₅ is crushed in the same form as the crush form of the section D₁. That is, an upper wall portion U₅ and a lower wall portion L₅ buckle to project to the outside of the section D₅ (see FIG. 5B).

Then, the section D₆ starts to be crushed. Here, the width d₆ of the section D₆ (that is, the length of an upper wall portion U₆ and a lower wall portion L₆ in the application direction of the pressing load (a buckling load)) is set to be smaller than the width d₅ of the section D₅ to be crushed before the section D₆. Accordingly, buckling loads of the upper wall portion U₆ and the lower wall portion L₆ are higher than buckling loads of the upper wall portion U₅ and the lower wall portion L₅. In other words, the upper wall portion U₆ and the lower wall portion L₆ can be hardly affected by deformations of the upper wall portion U₅ and the lower wall portion L₅. That is, a part constituted by the sections D₆ to D₅ can be considered to be separated from a part constituted by the sections D₁ to D₅. Accordingly, the sections D₆ to D₅ are crushed in the same forms as those of the sections D₁ to D₃, respectively (see to FIGS. 5C, 5D). That is, the upper wall portion U₅ and the lower wall portion L₅ deform to project to the outside of the section D₅. However, the upper wall portion U₆ and the lower wall portion L₆ buckle to project to the outside of the section D₆ (see FIG. 5C) in a similar manner to the upper wall portion U₁ and the lower wall portion L₁ without being affected by the deformations of the upper wall portion U₅ and the lower wall portion L₅. Further, an upper wall portion U₇ and a lower wall portion L₇ buckle to be folded to the inside of the section D₇. Further, an upper wall portion U₈ and a lower wall portion L₈ buckle to project to the outside of the section D₈ (see FIG. 5D).

### Result of Second Experiment

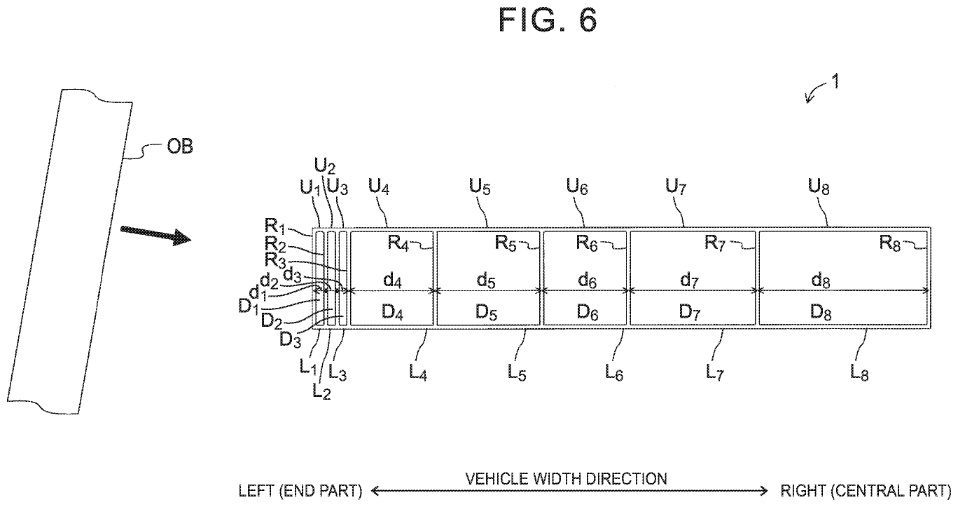

In the second experiment, the columnar object OB was caused to collide, from the left side, with the central part of the impact absorption device 1 in the vehicle front-rear direction (see FIG. 6), similarly to the first experiment. Note that, in the second experiment, as illustrated in the figure, the object OB is slightly inclined from the vertical direction (the vehicle height direction), that is, the object OB is inclined such that the upper side of the object OB is placed slightly on the right side from the lower side of the object OB. More specifically, the inclination angle of the object OB from the vertical direction is “5°.” In the present experiment, the sections D₁ to D₈ were crushed generally in the same forms as those in the first experiment, as described below.

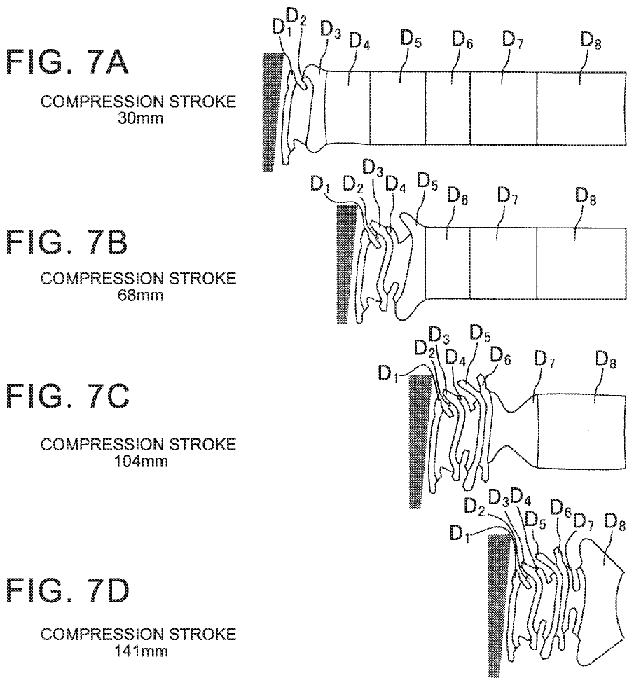

That is, the sections D₁ to D₈ were crushed in this order. As illustrated in FIGS. 7A, 7B, the upper wall portion U₁ and the lower wall portion L₁ buckle to project to the outside of the section D₁. Further, the upper wall portion U₂ and the lower wall portion L₂ buckle to be folded to the inside of the section D₂. Further, the upper wall portion U₃ and the lower wall portion L₃ buckle to project to the outside of the section D₃. Further, the upper wall portion U₄ and the lower wall portion L₄ buckle to be folded to the inside of the section D₄. Further, the upper wall portion U₅ and the lower wall portion L₅ buckle to project to the outside of the section D₅. Note that, in the present experiment, since the object OB is inclined as described above, a pressing load directed diagonally downward toward the right side is applied to each section Dₙ. On that account, the lower wall portion Lₙ buckles slightly earlier than the upper wall portion Uₙ. Hereby, as illustrated in the figures, the sections D₁ to D₅ slightly tilt downward.

Subsequently, as illustrated in FIG. 7C, the upper wall portion U₆ and the lower wall portion L₆ buckle to project to the outside of the section D₆. The section D₆ is crushed as such, but as described above, the width d₆ of the section D₆ is set to be smaller than the width d₅ of the section D₅ to be crushed before the section D₆. Accordingly, buckling strengths of the upper wall portion U₆ and the lower wall portion L₆ are higher than buckling strengths of the upper wall portion U₅ and the lower wall portion L₅. Accordingly, a difference between a buckling speed of the upper wall portion U₆ and a buckling speed of the lower wall portion L₆ is not so large. On this account, tilting in the section D₆ is smaller than tilting in the section D₅.

As illustrated in FIGS. 7C, 7D, the upper wall portion U₇ and the lower wall portion L₇ buckle to be folded to the inside of the section D₇. Further, the upper wall portion U₈ and the lower wall portion L₈ buckle to project to the outside of the section D₈. As illustrated in the figures, the sections D₇, D₈ also tilt slightly downward.

### Effects

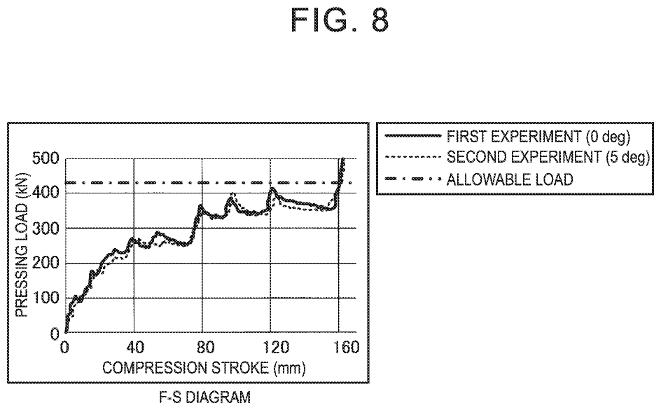

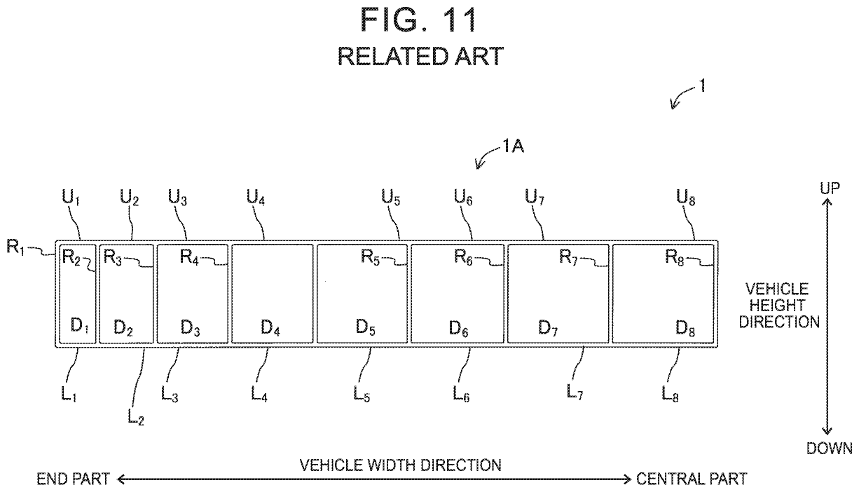

As described above, in these experiments, the width d₆ of the section D₆ placed in the intermediate part of the impact absorption device 1 in the vehicle width direction was set to be smaller than the width d₅ of the section D₅ placed on the left side of the section D₆ (on a reverse side in the advancing direction of the object OB). Hereby, tilting of the whole impact absorption device 1 could be set to be smaller than that of the example in the related art illustrated in FIG. 11. Hereby, such a situation that an uncrushed part remains in a section in the impact absorption device 1 could be prevented differently from the example in the related art, and an absorption amount of a collision energy in the first experiment and an absorption amount of a collision energy in the second experiment could be set to the same level. That is, as illustrated in FIG. 8, the change characteristic of a pressing load to an entry amount of the object OB (a compression stroke of the impact absorption device 1) in the second experiment is generally the same as the change characteristic in the first experiment.

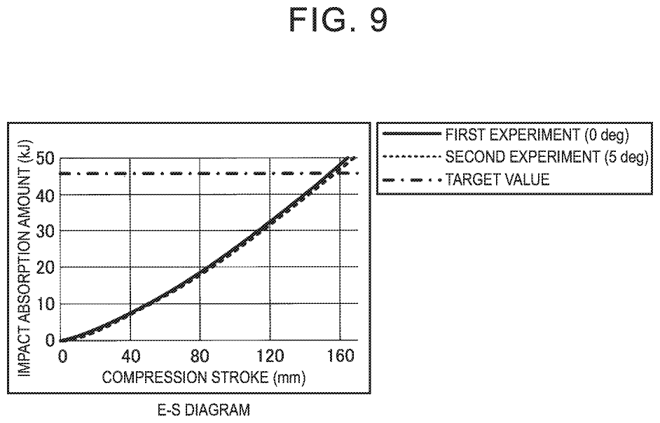

That is, with the impact absorption device 1, even in a case where the object OB collides (advances) in a direction slightly inclined from the arrangement direction of the sections D₁ to D₈ of the impact absorption device 1 (e.g., in a case where a vehicle having a relatively low vehicle height collides with a side part of a vehicle having a relatively high vehicle height), a collision energy can be absorbed sufficiently (see FIG. 9).

Further, as described above, the width d₁ of the section D₁ (that is, the length of the upper wall portion U₁ and the lower wall portion L₁ in a buckling-load direction) is set to be relatively small, so that a buckling load in the section D₁ is relatively high. That is, as illustrated in FIG. 8, a pressing load to be applied to the impact absorption device 1 rises steeply at an initial stage just after the object OB collides with the impact absorption device 1. Note that a peak of the pressing load does not exceed an allowable load.

Note that, at the initial stage, the upper wall portions U₂ to U₈ and the lower wall portions L₂ to L₈ do not buckle. As described above, the abutment part between the object OB and the rib R₁ is linear, and a load concentrates on the abutment part. However, in parts placed on the right side of the abutment part (particularly, the upper wall portions U₄ to U₈ and the lower wall portions L₄ to L₈), the pressing load disperses in the vehicle front-rear direction in those parts. Accordingly, even if the widths dₙ of the parts are large to some extent, the parts do not buckle. After that, as described above, the sections D₂ to D₈ are crushed in this order. However, in the course of crushing, the pressing load applied to the impact absorption device 1 does not exceed a predetermined allowable load. That is, in the course from a deformation start of the section D₁ to a deformation end of the section D₈, a state where a pressing load that was high to some extent was applied to the impact absorption device 1 could be maintained.

Further, in an impact absorption device 1A in the related art as illustrated in FIG. 11, an upper wall portion Uₙ₊₁ and a lower wall portion Lₙ₊₁ of a section Dₙ₊₁ are affected by deformations of the upper wall portion Uₙ and the lower wall portion Lₙ of the section Dₙ provided before the section Dₙ₊₁. That is, the upper wall portion Uₙ₌₂ₘ₋₁ and the lower wall portion Lₙ₌₂ₘ₋₁ in the section Dₙ₌₂ₘ₋₁ (the sections D₁, D₃, D₅, D₇) buckle to project to the outside of the section Dₙ₌₂ₘ₋₁. In the meantime, the upper wall portion Uₙ₌₂ₘ and the lower wall portion Lₙ₌₂ₘ in the section Dₙ₌₂ₘ (the sections D₂, D₄, D₆, D₈) buckle to be folded to the inside of the section Dₙ₌₂ₘ.

On the other hand, in the impact absorption device 1 of the present embodiment, the width d₆ of the section D₆ is set to be smaller than the width d₅ of the section D₅ to be crushed before the section D₆, so that the upper wall portion U₆ and the lower wall portion L₆ can be hardly affected by deformations of the upper wall portion U₅ and the lower wall portion L₅. Hereby, the upper wall portion U₆ and the lower wall portion L₆ can buckle to project to the outside of the section D₆. Then, the upper wall portion U₇ and the lower wall portion L₇ of the section D₇ are affected by the upper wall portion U₆ and the lower wall portion L₆ of the section D₆, so that the upper wall portion U₇ and the lower wall portion L₇ buckle to be folded to the inside of the section D₇. Further, the upper wall portion U₈ and the lower wall portion L₈ of the section D₈ are affected by the upper wall portion U₇ and the lower wall portion L₇ of the section D₇, so that the upper wall portion U₈ and the lower wall portion L₈ buckle to project to the outside of the section D₈.

As described above, in the case of the impact absorption device 1A, when the section D₈ is crushed, the upper wall portion U₈ and the lower wall portion L₈ buckle to the inside of the section D₈, so that the upper wall portion U₈ and the lower wall portion L₈ are sandwiched between the rib R₈ and the rib R₉. On the other hand, in the case of the impact absorption device 1, when the section D₈ is crushed, the upper wall portion U₈ and the lower wall portion L₈ buckle to the outside of the section D₈, so that the upper wall portion U₈ and the lower wall portion L₈ are not sandwiched between the rib R₈ and the rib R₉. Accordingly, a compression stroke in the section D₈ of the impact absorption device 1 is larger than a compression stroke in the section D₈ of the impact absorption device 1A. Accordingly, collision-energy absorption performance of the impact absorption device 1 is higher than that of the impact absorption device 1A.

As described above, by generally optimizing the number of ribs Rₙ and intervals therebetween (the number of sections Dₙ and the width dₙ), the impact absorption device 1 reduced in weight and having improved collision-energy absorption performance can be achieved.

Further, the present disclosure is not limited to the above embodiment, and various alterations can be made within a range that does not deviate from the object of the present disclosure.

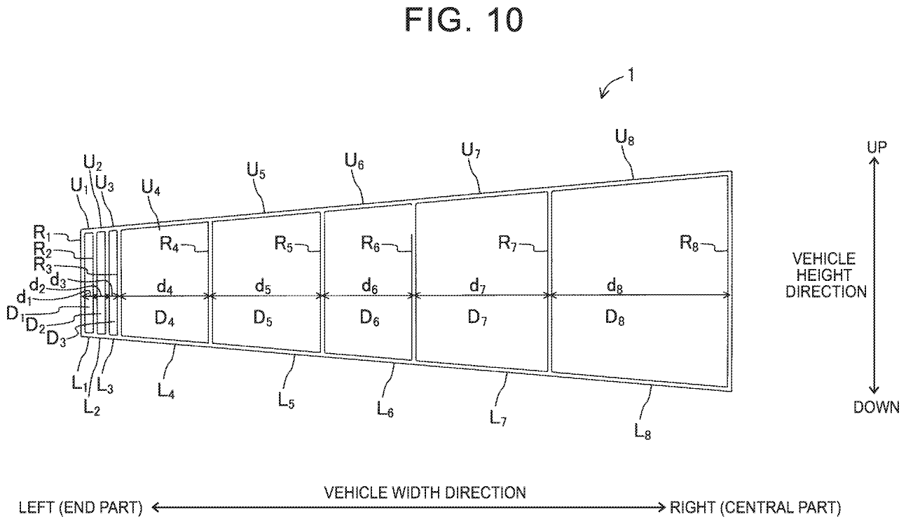

For example, in the above embodiment, the upper wall portion U and the lower wall portion L are placed in parallel to each other. However, for example, as illustrated in FIG. 10, the upper wall portion U may be inclined such that the left end of the upper wall portion U is placed below the right end of the upper wall portion U, and the lower wall portion L may be inclined such that the left end of the lower wall portion L is placed above the right end of the lower wall portion L. That is, a distance, in the vehicle height direction, of the left end of the upper wall portion U and the left end of the lower wall portion L may be set to be smaller than a distance, in the vehicle height direction, of the right end of the upper wall portion U and the right end of the lower wall portion L. In this configuration, in a case where the object OB collides with the impact absorption device 1 in a state where the object OB is slightly inclined to the arrangement direction of the sections D₁ to D₈ like the second experiment, for example, an angular difference between the application direction of a load to the lower wall portion L and the inclination direction of the lower wall portion L is relatively small, so that tilting of the impact absorption device 1 can be easily restrained.

Further, the number of sections in the impact absorption device 1 is not limited to the above embodiment, for example. Note that it is preferable that the width dₙ of one section Dₙ placed in the intermediate part in the arrangement direction of the sections be set to be smaller than a width dₙ₋₁ and a width dₙ₊₁ of a section Dₙ₋₁ and a section Dₙ₊₁, adjacently provided on both sides of the one section Dₙ, and the number of sections placed on the right side (in the advancing direction of the object OB) relative to the rib Rₙ constituting the one section Dₙ in the intermediate part be set to an odd number. In this configuration, the upper wall portion and the lower wall portion constituting a last section to be crushed buckle to project to the outside of the last section. Hereby, in comparison with a case where the upper wall portion and the lower wall portion constituting the last section to be crushed buckle to be folded to the inside of the last section, a large compression stroke can be achieved, so that collision-energy absorption performance can be set to be high.

Further, the width d₆ of the section D₆ that is a central section among three consecutive sections D₅, D₆, D₇ in the impact absorption device 1 in the above embodiment is smaller than the width d₅ of the section D₅ and the width d₇ of the section D₇, the section D₅ and the section D₇ being adjacently placed on both sides of the section D₆. The impact absorption device 1 includes a set part D₅-D₆-D₇ constituted by the three consecutive sections as described above, but the impact absorption device 1 may include a plurality of set parts D₅-D₆-D₇. Further, the central section D₆ in the part D₅-D₆-D₇ may be divided into a plurality of sections.

In an aspect of the present disclosure, an interval between ribs constituting one given section in a part adjacently placed on either side of the three consecutive sections among the sections may be equal to or more than an interval between ribs constituting an adjacent section adjacently placed on a reverse side of the one given section in the advancing direction of the object.

Further, in the aspect of the present disclosure, the number of sections placed on a forward side, in the advancing direction of the object, from a rib placed on the reverse side in the advancing direction of the object out of two ribs constituting the central section may be an odd number.

Further, in the aspect of the present disclosure, the upper wall portion and the lower wall portion may be placed in parallel to each other.

Further, in the aspect of the present disclosure, an interval, in the vehicle height direction, between first end parts of the upper wall portion and the lower wall portion may be smaller than an interval, in the vehicle height direction, between second end parts of the upper wall portion and the lower wall portion, the first end parts being placed on the reverse side in the advancing direction of the object, the second end parts being placed on the forward side in the advancing direction of the object.

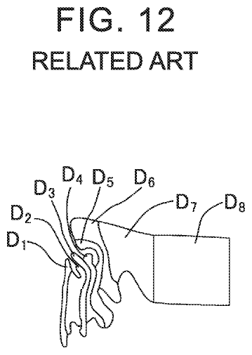

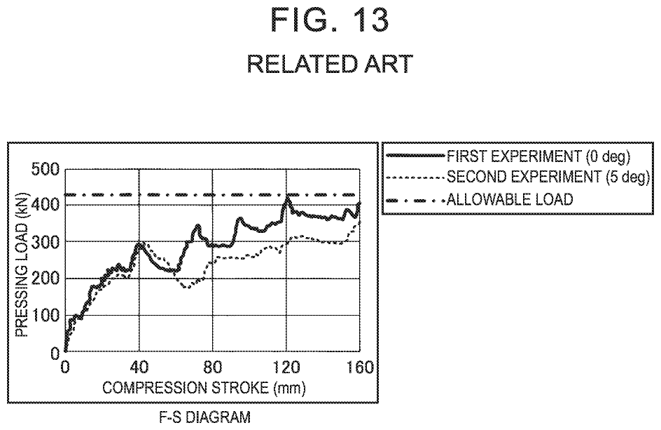

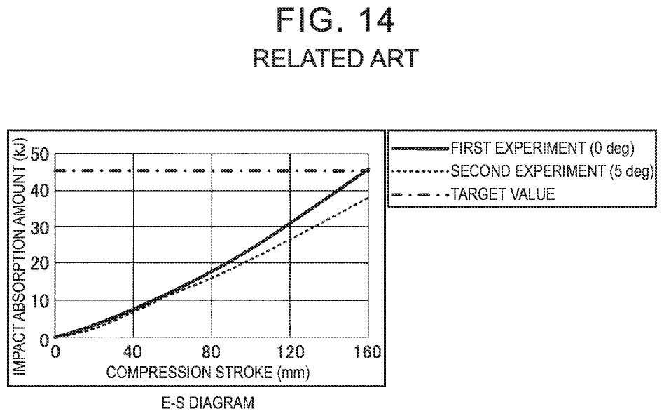

In the impact absorption device according to the aspect of the present disclosure, a width (the interval between the ribs constituting the central section) of a part (hereinafter referred to as a first part) of each of the upper wall portion and the lower wall portion, the part constituting the central section, is smaller than a width of a part (hereinafter referred to as a second part) of each of the upper wall portion and the lower wall portion, the part constituting a section adjacently placed on either side of the central section. Accordingly, a buckling strength of the first part is higher than a buckling strength of the second part. Accordingly, even if the object collides with the vehicle in a state where the object is slightly inclined from the arrangement direction of the sections, a difference between a buckling speed of the upper wall portion in the first part and a buckling speed of the lower wall portion in the first part is not so large. On this account, tilting in the central section is smaller than tilting in the sections adjacently provided on both sides of the central section. As such, with the impact absorption device of the present disclosure, tilting in the central section is relatively small. In the example illustrated in FIG. 12, tilting caused in each section is accumulated, and an uncrushed part remains in a last section. However, in the impact absorption device of the present disclosure, tilting in a section crushed earlier than the central section can hardly affect the central section and sections subsequent to the central section, thereby making it possible to restrain an uncrushed part illustrated in the example of FIG. 7. Accordingly, the present disclosure can provide an impact absorption device having improved collision-energy absorption performance.

What is claimed is:

1. An impact absorption device for absorbing a collision energy by deforming when an object collides with a side part of a vehicle from a lateral side of the vehicle toward a central part side of the vehicle in a vehicle width direction, the impact absorption device comprising:
a pair of an upper wall portion and a lower wall portion extending in a vehicle front-rear direction in the side part of the vehicle, the upper wall portion and the lower wall portion being distanced from each other in a vehicle height direction and placed to face each other; and
a plurality of ribs extending in the vehicle front-rear direction between the upper wall portion and the lower wall portion, the ribs being arranged at predetermined intervals in the vehicle width direction so as to divide a space between the upper wall portion and the lower wall portion into a plurality of sections extending in the vehicle front-rear direction, wherein, among the sections, three consecutive sections in an arrangement direction of the sections are configured such that an interval between ribs constituting a central section in the arrangement direction is smaller than an interval between ribs constituting each of sections adjacently placed on both sides of the central section.

2. The impact absorption device according to claim 1, wherein an interval between ribs constituting one given section in a part adjacently placed on either side of the three consecutive sections among the sections is equal to or more than an interval between ribs constituting an adjacent section adjacently placed on a reverse side of the one given section in an advancing direction of the object.

3. The impact absorption device according to claim 1, wherein the number of sections placed on a forward side, in an advancing direction of the object, from a rib placed on a reverse side in the advancing direction of the object out of two ribs constituting the central section is an odd number.

4. The impact absorption device according to claim 1, wherein the upper wall portion and the lower wall portion are placed in parallel to each other.

5. The impact absorption device according to claim 1, wherein an interval, in the vehicle height direction, between first end parts of the upper wall portion and the lower wall portion is smaller than an interval, in the vehicle height direction, between second end parts of the upper wall portion and the lower wall portion, the first end parts being placed on a reverse side in an advancing direction of the object, the second end parts being placed on a forward side in the advancing direction of the object.
